(19) United States
(12) Patent Application Publication
(10) Pub. No.: US 2015/0061331 A1
(43) Pub. Date: Mar. 5, 2015

(54) BREATHABLE SEAT CUSHIONING AND SEATING DEVICE FOR CHILDREN

(71) Applicant: CHING-LUN YANG, TAIPEI CITY (TW)

(72) Inventor: CHING-LUN YANG, TAIPEI CITY (TW)

(21) Appl. No.: 14/070,512

(22) Filed: Nov. 2, 2013

(30) Foreign Application Priority Data
Aug. 30, 2013 (TW) 102216339

(51) Int. Cl. B60N 2/56; A47C 7/72; B60N 2/26

(52) U.S. Cl. CPC B60N 2/5642; B60N 2/26; B60N 2/5678; A47C 7/72
USPC 297/180.14

(57) ABSTRACT

A breathable seat cushioning device includes a seat body, a plurality of air conduits, an air permeable body, a fan module, and a heater. The seat body has a plurality of receiving grooves longitudinally arranged thereon. The air conduits have a plurality of air outlets arranged thereon. The air conduits are disposed in the receiving grooves. The air permeable body covers a surface of the seat body. The fan module is connected to the air conduits and has a casing and at least one blade pivotally coupled to the interior of the casing. The heater is arranged inside or outside the fan module. As a result, active ventilation is provided to prevent poor air permeability which can cause unpleasant seating conditions such as stuffy, perspiration, to children sitting on the breathable seat cushioning device. Moreover, warm air flow can be provided during colder environment.

### BACKGROUND OF THE INVENTION

1. Field of the Invention

The instant disclosure relates to a breathable seat cushioning and seating device for children; in particular, to a ventilating breathable seat cushioning and seating device for children.

2. Description of Related Art

As parents make preparation to bring their children on a car ride, child safety seats are likely to be part of the preparation. However, conventional child safety seats tend to lead children to perspiration after a prolong period of use due to poor breathability of the seat, which further leads to dampened clothing on children and the possibility of catching a cold if for example a child was hit by cold wind. In other case, children may feel stuffy or uncomfortable due to poor breathability and thus affect other passengers in the car.

Conventional child safety seats have breathable structure yet passive breathable designs, such as forming air permeable openings, to improve air ventilation. However, the level of ventilation is not apparent. Moreover, current safety seats do not have heater, music player functionalities which can provide a comfortable riding environment for children.

To address the above issues, the inventor strives via associated experience and research to present the instant disclosure, which can effectively improve the limitation described above.

### SUMMARY OF THE INVENTION

In order to achieve the aforementioned objects, a breathable seat cushioning and seating device for children having active ventilation is provided to prevent stuffiness, uncomfortable, and unwanted perspiration due to poor breathability.

The instant disclosure also provides a breathable seat cushioning and seating device for children having heating and music or broadcast playback functionalities to provide a comfortable riding environment.

The instant disclosure also provides a breathable seat cushioning and seating device for children, which includes a seat body having a plurality of receiving grooves longitudinally arranged thereon; a plurality of air conduits respectively disposed in the receiving grooves and each air conduit having a plurality of air outlets arranged thereon; an air permeable body enclosing a surface of the seat body; a fan module having a casing and at least one fan blade pivotally coupled to and arranged in the casing, wherein the fan module is in air communication with the air conduits; and a heater configured inside or outside the fan module.

The instant disclosure also provides a breathable seat cushioning and seating device for children, which includes a seat body having a plurality of receiving grooves longitudinally arranged thereon; a plurality of air conduits respectively disposed in the receiving grooves with each air conduit having a plurality of air outlets arranged thereon; an air permeable body enclosing a surface of the seat body; a fan module having a casing and at least one fan blade pivotally coupled to and arranged in the casing, wherein the fan module is in air communication with the air conduits; and an playback device arranged on the fan module or the seat body.

The instant disclosure also provides a breathable seat cushioning and seating device for children, which includes a seat body having a plurality of receiving grooves longitudinally arranged thereon; a plurality of air conduits respectively disposed in the receiving grooves with each air conduit having a plurality of air outlets arranged thereon; an air permeable body enclosing a surface of the seat body; and a fan module having a casing and at least one fan blade pivotally coupled to and arranged in the casing, wherein the fan module is in air communication with the air conduits.

The instant disclosure also provides a breathable seat cushioning and seating device for children, which includes a seat body having a plurality of receiving grooves longitudinally arranged thereon, and a front side of the seat body having an air permeable portion in air communication with the receiving grooves; a plurality of air conduits respectively disposed in the receiving grooves and each air conduit having a plurality of air outlets arranged thereon; a fan module having a casing and at least one fan blade pivotally coupled to and arranged in the casing, wherein the fan module is in air communication with the air conduits; and a heater configured in or out of the fan module.

The instant disclosure provides the following improvements:

The plurality of air conduits are disposed in the seat body and connected to the fan module, in which when the fan module is in operation, airflow is diverted to the seat body and the permeable body, such that active ventilation is provided to the seat body and the air permeable body. Preferably, when a child is seating on the breathable seat cushioning device of the instant disclosure, the active ventilation can prevent stuffiness, uncomforting, and unwanted perspiration due to poor breathability.

The heater can provide warm air flow if preferred, especially during colder weather to provide children with comfortable riding environment. The heater is arranged on the fan module such that a single modular design is provided to facilitate assembly and repair.

The playback device can provide music or broadcast playback functionalities to provide children with comfortable riding environment. The playback device is arranged on the fan module such that a single modular design is provided to facilitate assembly and repair.

In order to further understand the instant disclosure, the following embodiments and illustrations are provided. However, the detailed description and drawings are merely illustrative of the disclosure, rather than limiting the scope being defined by the appended claims and equivalents thereof.

### BRIEF DESCRIPTION OF THE DRAWINGS

FIG. 1 is an exploded view of a breathable seat cushioning device for children in accordance with a first embodiment of the instant disclosure;

FIG. 2 is another exploded view according to FIG. 1;

FIG. 3 is an assembled view according to FIG. 1;

FIG. 4 is an exploded view illustrating a partial structure of the breathable seat cushioning device for children in accordance with a second embodiment of the instant disclosure;

FIG. 5 is a perspective view of the breathable seat cushioning device for children in accordance with a third embodiment of the instant disclosure;

FIG. 6 is a perspective view of the breathable seat cushioning device for children in accordance with a fourth embodiment of the instant disclosure;

FIG. 7 is an exploded view of the breathable seat cushioning device for children in accordance with a fifth embodiment of the instant disclosure; and

FIG. 8 is an assembled view according to FIG. 7.

### DETAILED DESCRIPTION OF THE PREFERRED EMBODIMENTS

### First Embodiment

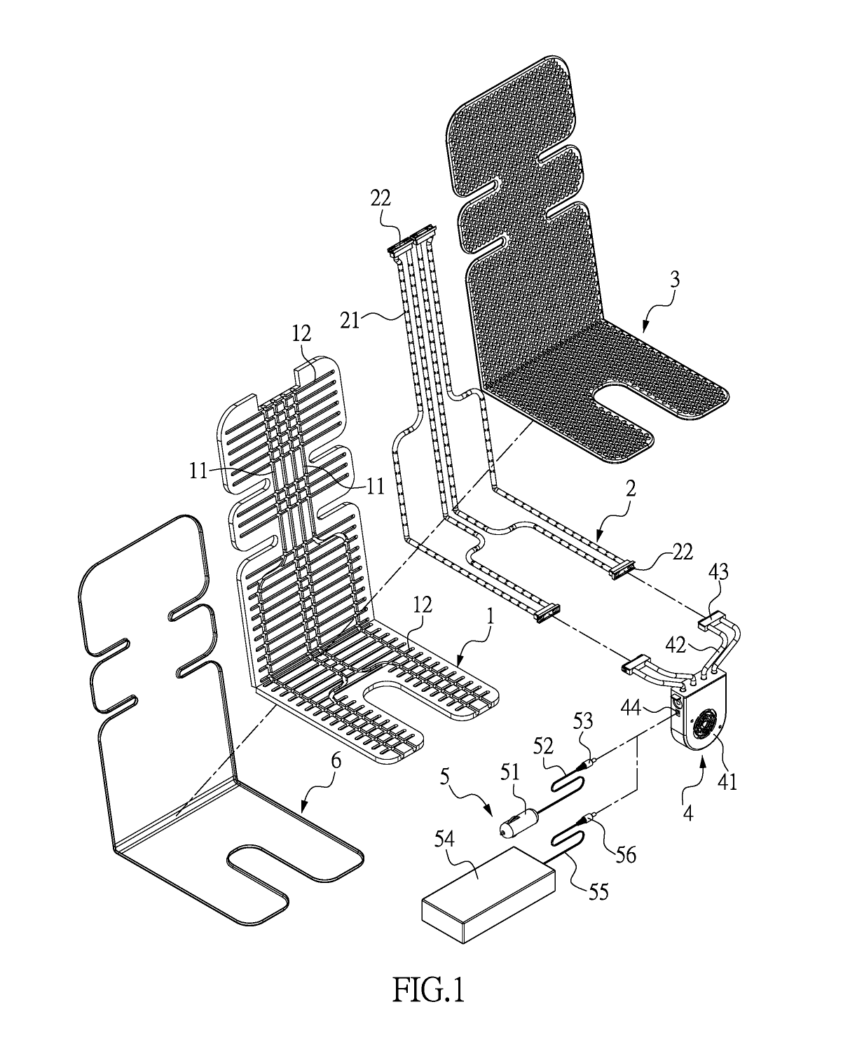

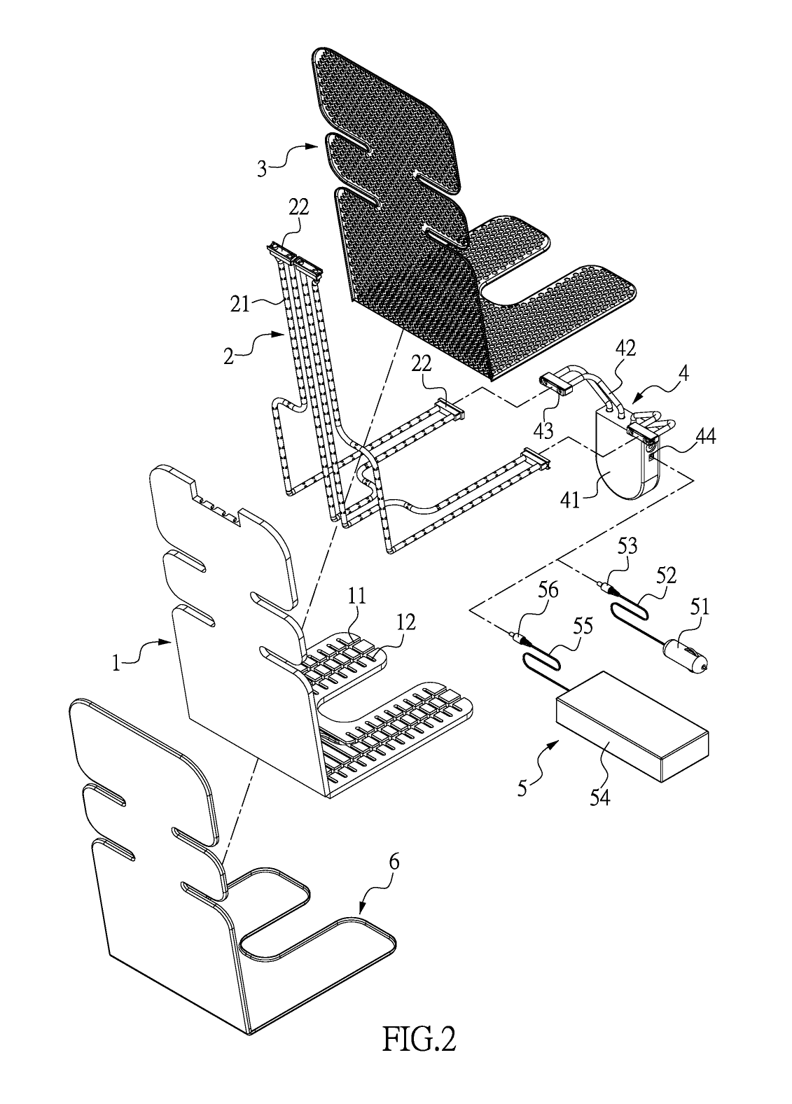

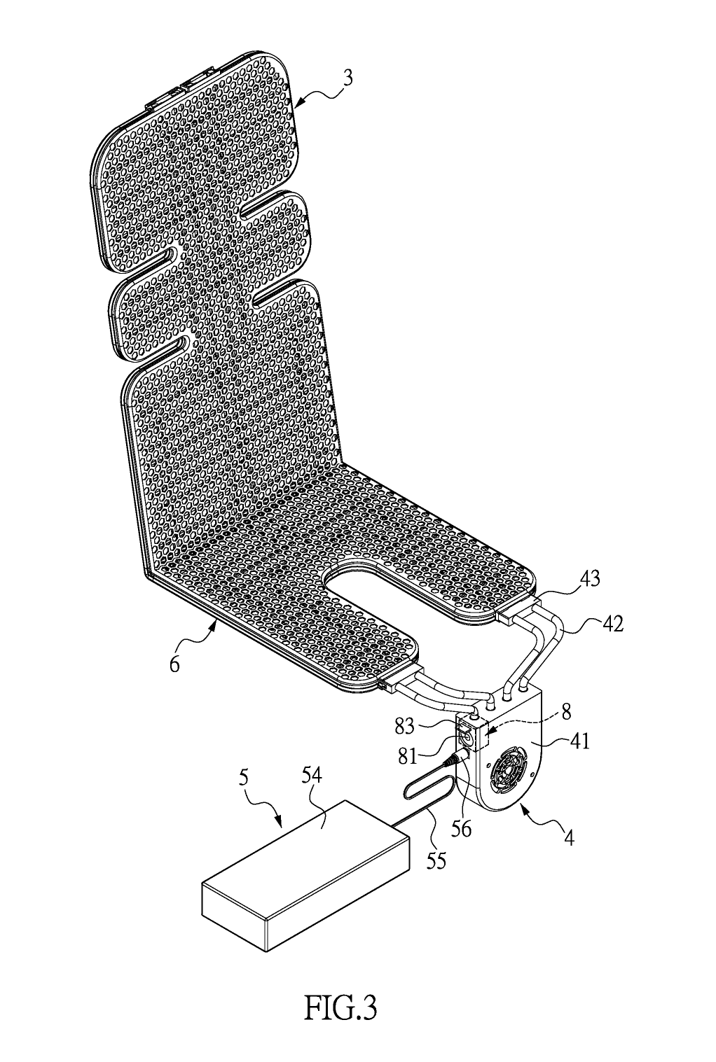

Please refer to FIGS. 1 to 3. The instant disclosure provides a breathable seat cushioning device for children which includes a seat body 1, a plurality of air conduits 2, an air permeable body 3, and a fan module 4.

The seat body 1 is preferably but not limited to flexible components, which can be made of foam in order to provide comfortable seating. The seat body 1 has a plurality of receiving grooves 11 longitudinally arranged thereon. The receiving grooves 11 are arranged from an upper end of the seat body 1 to a lower end of the seat body 1. The receiving grooves 11 collectively have an overall shape that is configured to align with the contour of the seat body 1 via curve and straight line designs. The seat body 1 may further have a plurality of guiding grooves 12 laterally arranged thereon and transversely arranged with respect to the receiving grooves 11.

The air conduits 2 are preferably but not limited to flexible components. Each of the air conduits 2 has a plurality of spaced apart air outlets 21 arranged thereon. The air outlets 21 run through inner wall and outer wall of the air conduit 2. The air conduits 2 can be disposed in the receiving grooves 11 of the seat body 1. However, the air conduits 2, the receiving grooves 11, and the guiding grooves 12 forming a guiding flow structure is not limited to the example provided herein and similar alternatives. Preferably, air flow generated by the fan module 4 can be guided towards the seat body 1 and the air permeable body 3. For example, other types of air tubes, guiding grooves or openings can be arranged to guide the air flow generated by the fan module 4 to the seat body 1 and the air permeable body 3. Each air conduit 2 has an upper end and a lower end which may have a first coupling portion 22 arranged thereon.

The air permeable body 3 is an air permeable component made of woven or non-woven materials. The air conduits 2 are respectively disposed in the receiving grooves 11 of the seat body 1, and the air permeable body 3 covers one surface of the seat body to conceal the seat body 1 and the air conduits 2.

The fan module 4 is air communicable with the air conduits 2. The fan module 4 can be centrifugal or axial flow type fans, but the type and structure of the fans are not limited to the examples provided hereto. The fan module 4 of the instant embodiment has a casing 41 connected to a plurality of air supplying conduits 42. One end of each air supplying conduit 42 has a second coupling portion 43 arranged thereon. The first coupling portion 22 and the second coupling portion 43 are corresponding male and female connectors. The second coupling portions 43 can be connected to the first coupling portions 22 at the upper ends or the lower ends of the air conduits 2, such that the fan module 4 is in air communication with the air conduits 2. When the fan module 4 is in operation, suctioned air flow is generated and diverted to the air supplying conduits 42, and then provided to the air conduits 2. However, the structure of the connection between the air conduits and the fan module 4 is not limited hereto. The air conduits 2 can be connected to the fan module 4 via other types of connectors or air flow guiding structures, such that air flow generated by the fan module 4 is diverted to the air conduits 2. Moreover, the fan module 4 may have an adaptor receptacle 44 arranged thereon to couple to plugs or connectors of external electrical transmitting devices.

The fan module 4 may further be electrically connected to an electrical transmitting device 5 in order to provide preferred electrical power or serve as electrical adapter for the fan module 4. Specifically, the electrical transmitting device 5 can be a vehicle adapter 51 which is connected to a transmission cable 52, such as an electrical wiring, and a connector 53. The connector 53 can be mated, for example plugging in, to the adaptor receptacle 44 of the fan module 4. The vehicle adapter 51 can be mated, for example plugging in, to the cigarette lighter receptacle in a vehicle in order to transmit sufficient electricity to the fan module 4. The electrical transmitting device 5 can also be a rechargeable battery 54 which is connected to a transmission cable, such as an electrical wiring, and a connector 56. The connector 56 can be mated, for example plugging in, to the adaptor receptacle 44 of the fan module 4 as the rechargeable battery 54 transmits sufficient electricity to the fan module 4. However, the type and structure of the electrical transmitting device 5 is not limited hereto, and can be solar powered battery or other types of electrical transmitting devices.

The instant disclosure can further include a rear drapery 6, which is disposed on and covering a surface of the seat body 1 opposite the air permeable body 3 in order to conceal the seat body 1 and increase aesthetic value.

When the fan module 4 is in operation, air flow is conveyed towards the air conduits 2, flows through the air conduits 2, further exits through the air outlets 21. The air flow can also travels through the receiving grooves 11 and the guiding grooves 12, and in turn permeates through the air permeable body 3 of the breathable seat cushioning device for children in the instant disclosure. Moreover, as the seat body 1 has the laterally arranged guiding grooves 12, air flow can be diverted to other portions of the seat body 1, which increases the surface area of regions where airflow has traveled in the seat body 1, thus increasing permeability during seating.

The plurality of air conduits 2 of the instant disclosure are disposed in the seat body 1 and are connected to the fan module 4. The fan module 4 in operation provides airflow, whereas the air conduits 2 diverts airflow to the seat body 1 and the air permeable body 3, such that active ventilation is provided to the seat body 1 and the air permeable body 3. Preferably, when a child is seating on the breathable seat cushioning device of the instant disclosure, the active ventilation can prevent stuffiness, uncomfortable, and unwanted perspiration due to poor breathability.

### Second Embodiment

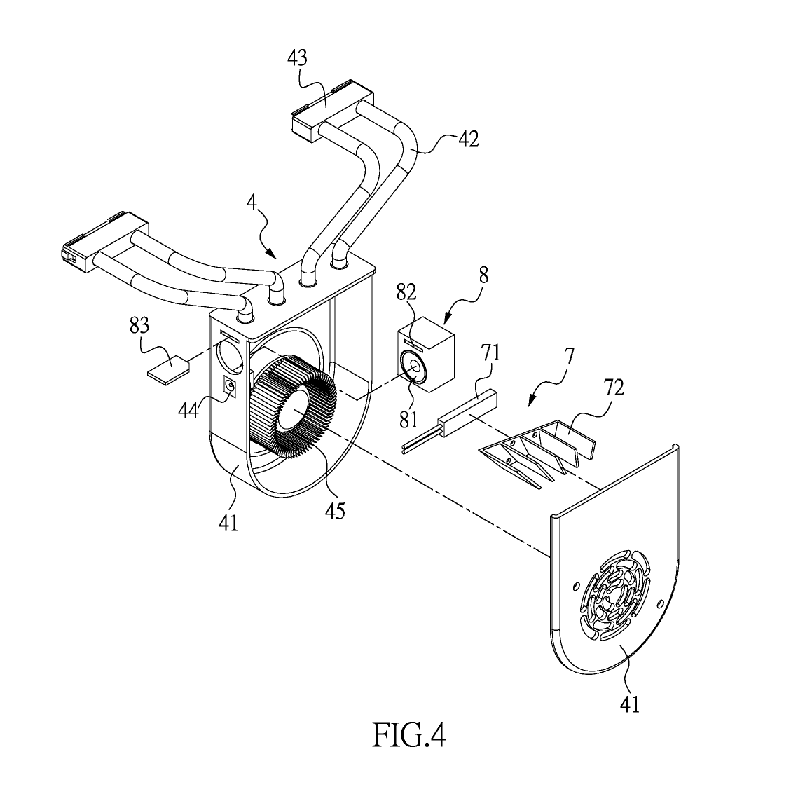

Please refer to FIG. 4. The fan module 4 of the instant embodiment has a casing 41 and at least one fan blade 45 pivotally coupled to the casing 41. The blades 45 are centrifugal fan blades. When the blades 45 are in rotation, air is sucked into the air supplying conduits 42, and further directed to the air conduits 2. In the instant embodiment, a heater 7 is further included which can be an electric heater or similar types of heat generating devices. The heater 7 is installed within or outside of the fan module 4. Namely, the heater 7 is installed within the casing 41 of the fan module 4. The heater 7 can also include a heat generating member 71 and at least one thermally conducting fin 72 connected to the heat generating member 71. The heating generating member 71 can be a ceramic heating element, through which air is heated via the heater 7 such that heated air flow is provided to the breathable seat cushioning device of the instant disclosure and further provides warmth and comfort to children during each seating in a relatively cold environment. Moreover, the heater 7 is installed on the fan module 4 to provide a single modular design which facilitates assembly and repair.

Furthermore, the instant disclosure further provides a playback device 8 installed on the fan module 4 or the seat body 1. Namely, the playback device 8 can be installed on the casing 41 of the fan module 4. The playback device 8 can be a multimedia audio-visual playback device (such as MP3, MP4, MP5, etc). The playback device 8 can also include a built-in speaker 81, which facilitates playback of music, broadcast, etc. The playback device 8 has a media interface 82 which can be USB slots or other types of memory slot. The media interface 82 of the instant disclosure is a memory slot, in which a memory card 83 can be inserted. The media interface 82 can be used to read digital music, broadcast, or similar types of files, and playback music or broadcast via the playback device 8, such that music or broadcast can be provided to the breathable seat cushioning device of the instant disclosure. In addition, the playback device 8 can be installed on the fan module 4 in order for a single modular design which facilitates assembly and repair.

### Third Embodiment

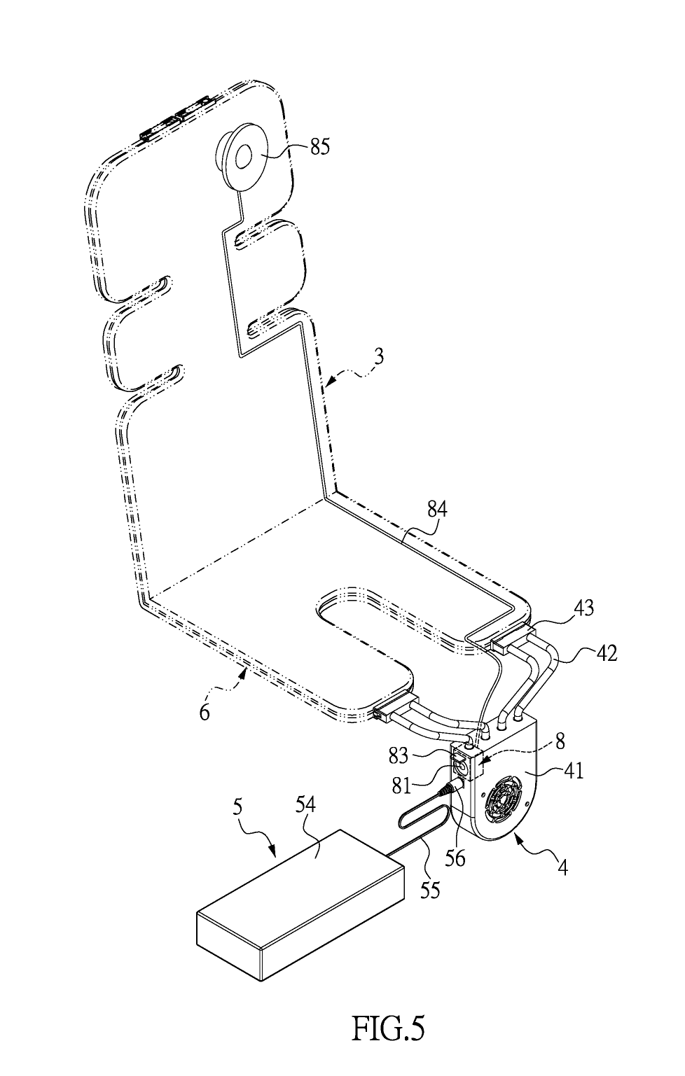

Please refer to FIG. 5. The playback device 8 in the instant embodiment is connected to an external speaker 85 via a transmission cable 84. The transmission cable 84 can be installed in the receiving grooves 11 in order to facilitate proper installment of the external speakers onto the seat body 1 and provide users with music or broadcast entertainment.

### Fourth Embodiment

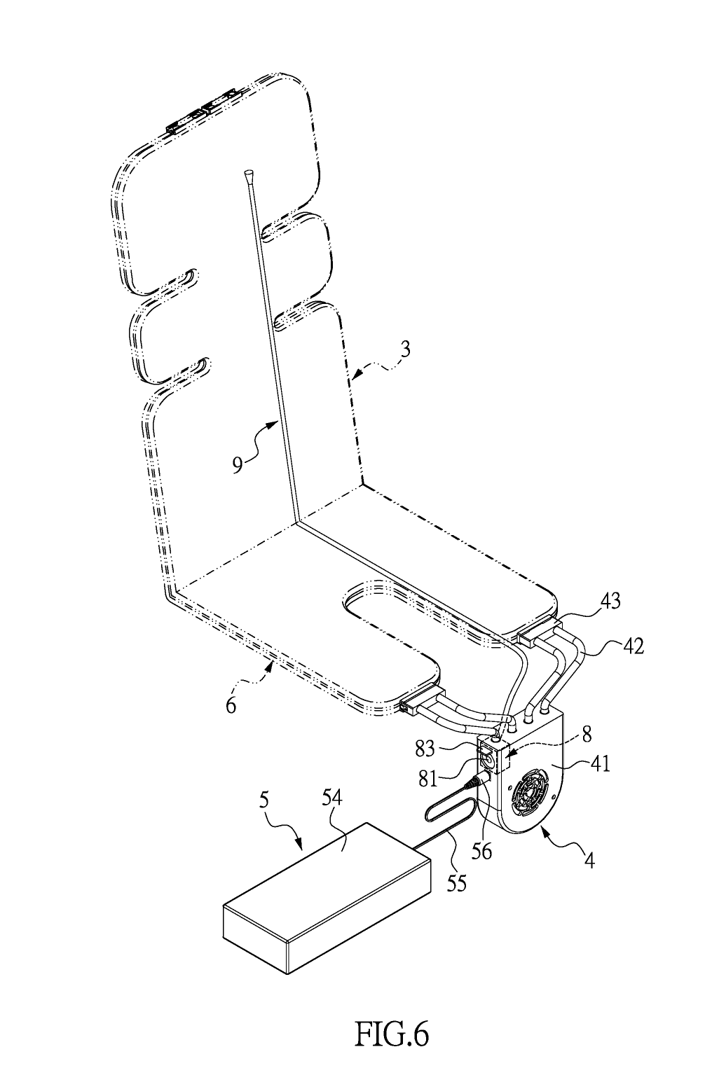

Please refer to FIG. 6. In the instant embodiment, a sound guiding tube 9 is included which is disposed in some of the receiving grooves 11. The sound guiding tube 9 can be a graphite tube or similar type of tubes having sound guiding properties. One end of the sound guiding tube 9 is connected to the built-in speaker 81 of the playback device 8, such that music or broadcast playback from the built-in speaker 81 can be transferred from one end of the sound guiding tube 9 to another end of the sound guiding tube 9, which facilitates playback.

### Fifth Embodiment

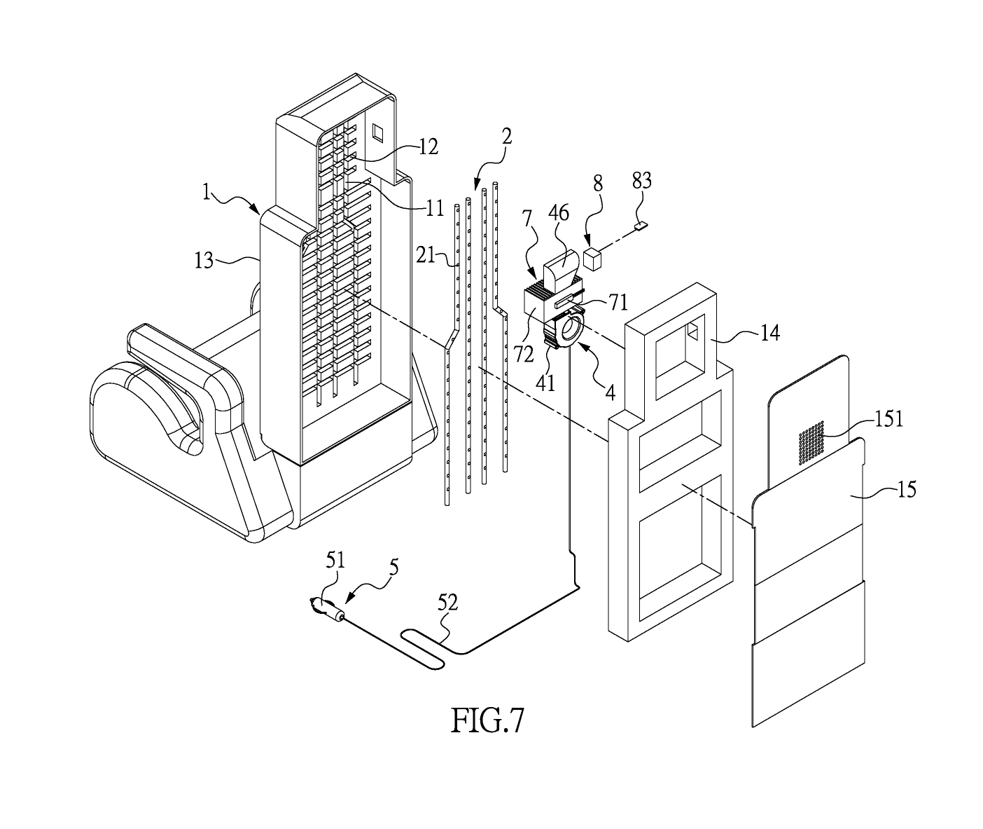

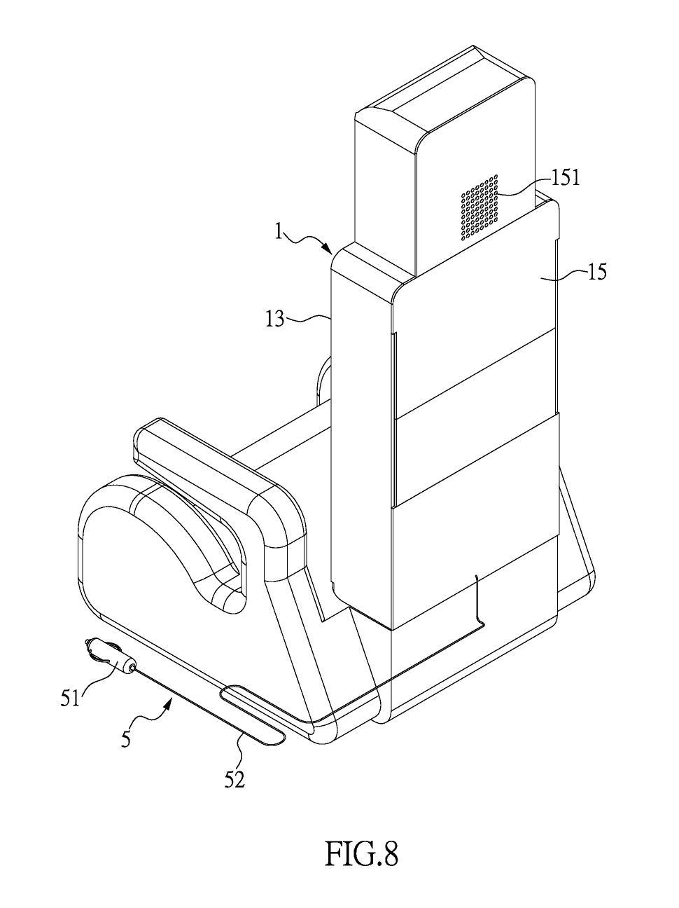

Please refer to FIGS. 7 and 8. The instant embodiment provides a breathable seat cushioning device including a seat body 1, a plurality of air conduits 2, a fan module 4, and a heater 7. The seat body 1 has a plurality of receiving grooves 11 longitudinally arranged thereon. The seat body 1 also has a plurality of guiding grooves 12 laterally arranged thereon and transversely arranged with respect to the receiving grooves. Front side of the seat body 1 has an air permeable portion 13, which is an air permeable component and air communicable with the receiving grooves 11. The air permeable portion 13 is made of, for example, woven or non-woven materials but not limited hereto.

Each of the air conduits 2 has a plurality of air outlets 21 arranged thereon. The air conduits 2 are disposed in the receiving grooves 11 of the seat body 1. The heater 7 includes a heat generating member 71 and at least one thermally conducting fin 72 connected to the heat generating member 71. The heater 7 is installed within or outside the fan module 4. The instant embodiment also includes a playback device 8 installed on the fan module 4 or the seat body 1. The fan module 4 is electrically connected to an electrical transmitting device 5 in order to provide preferred electrical power or serve as electrical adapter for the fan module 4. The electrical transmitting device 5 can be a vehicle adapter 51 which is connected to a transmission cable 52. One end of the transmission cable 52 is connected to the fan module 4. The vehicle adapter 51 can be mated, for example plugging in, to the cigarette lighter receptacle in a vehicle in order to transmit the sufficient electricity to the fan module 4. In the instant embodiment, the seat body 1 has a frame body 14 disposed therein. The fan module 4 and the heater 7 are disposed and fixed in the frame body 14. A back side of the seat body 1 may have a detachable rear panel 15 fixed thereon by screws or similar types of securing method. The rear panel 15 has a plurality of air inlets 151 arranged thereon to facilitate air inflow.

The figures and descriptions supra set forth illustrated the preferred embodiments of the instant disclosure; however, the characteristics of the instant disclosure are by no means restricted thereto. All changes, alternations, combinations or modifications conveniently considered by those skilled in the art are deemed to be encompassed within the scope of the instant disclosure delineated by the following claims.

What is claimed is:

1. A breathable seat cushioning and seating device for children, comprising:
a seat body having a plurality of receiving grooves longitudinally arranged thereon;
a plurality of air conduits respectively disposed in the receiving grooves and each air conduit having a plurality of air outlets arranged thereon;
an air permeable body enclosing a surface of the seat body;
a fan module having a casing and at least one fan blade pivotally coupled to and arranged in the casing, wherein the fan module is in air communication with the air conduits; and
a heater disposed proximate to an air outlet of the fan module.

2. The breathable seat cushioning and seating device as recited in claim 1, wherein the seat body has a plurality of guiding grooves laterally arranged thereon and transversely arranged with respect to the receiving grooves.

3. The breathable seat cushioning and seating device as recited in claim 1, wherein each air conduit has an upper end and a lower end, each end has a first coupling portion arranged thereon, the casing is coupled to a plurality of air supplying conduits, one end of the air supplying conduits has a second coupling portion arranged thereon, and the second coupling portions are respectively coupled to the first coupling portions of the air conduits at the upper end or the lower end.

4. The breathable seat cushioning and seating device as recited in claim 1, wherein the heater includes a heat generating member and at least one thermally conducting fin connected to the heat generating member and is arranged in the casing of the fan module.

5. The breathable seat cushioning and seating device as recited in claim 1 further comprising:
a playback device on the fan module or the seat body.

6. The breathable seat cushioning and seating device as recited in claim 5, wherein the playback device has a built-in speaker arranged therein.

7. The breathable seat cushioning and seating device as recited in claim 6, wherein portions of the receiving grooves are adapted for at least one sound guiding tube to be disposed therein, and the sound guiding tube has an end connected proximate to the built-in speaker of the playback device.

8. The breathable seat cushioning and seating device as recited in claim 5, wherein the playback device has a media interface such as an USB slot or a memory slot.

9. The breathable seat cushioning and seating device as recited in claim 5, wherein the playback device has an external speaker connected thereto via a transmission cable, the transmission cable is disposed in portions of the receiving grooves, and the external speaker is arranged on the seat body.

10. A breathable seat cushioning device for children, comprising:
a seat body having a plurality of receiving grooves longitudinally arranged thereon;
a plurality of air conduits respectively disposed in the receiving grooves and each air conduit having a plurality of air outlets arranged thereon;
an air permeable body enclosing a surface of the seat body;
a fan module having a casing and at least one fan blade pivotally coupled to and arranged in the casing, wherein the fan module is in air communication with the air conduits; and
a playback device arranged on the fan module or the seat body.

11. The breathable seat cushioning device as recited in claim 10, wherein the seat body has a plurality of guiding grooves laterally arranged thereon and transversely arranged with respect to the receiving grooves.

12. The breathable seat cushioning device as recited in claim 10, wherein each air conduit has an upper end and a lower end, each end has a first coupling portion arranged thereon, the casing is coupled to a plurality of air supplying conduits, one end of the air supplying conduits has a second coupling portion arranged thereon, and the second coupling portions are respectively coupled to the first coupling portions of the air conduits at the upper end or the lower end.

13. The breathable seat cushioning device as recited in claim 10, wherein the playback device has a built-in speaker arranged therein.

14. The breathable seat cushioning device as recited in claim 13, wherein portions of the receiving grooves are adapted for at least one sound guiding tube to be disposed therein, and the sound guiding tube has an end connected proximate to the built-in speaker of the playback device.

15. The breathable seat cushioning device as recited in claim 10, wherein the playback device has a media interface such as an USB slot, or a memory slot.

16. The breathable seat cushioning device as recited in claim 10, wherein the playback device has an external speaker connected thereto via a transmission cable, the transmission cable is disposed in portions of the receiving grooves, and the external speaker is arranged on the seat body.

17. A breathable seat cushioning device for children, comprising:
a seat body having a plurality of receiving grooves longitudinally arranged thereon;
a plurality of air conduits respectively disposed in the receiving grooves and each air conduit having a plurality of air outlets arranged thereon;
an air permeable body enclosing a surface of the seat body; and
a fan module having a casing and at least one fan blade pivotally coupled to and arranged in the casing, wherein the fan module is in air communication with the air conduits.

18. The breathable seat cushioning device as recited in claim 17, wherein the seat body has a plurality of guiding grooves laterally arranged thereon and transversely arranged with respect to the receiving grooves.

19. The breathable seat cushioning device as recited in claim 17, wherein each air conduit has an upper end and a lower end, each end has a first coupling portion arranged thereon, the casing is coupled to a plurality of air supplying conduits, one end of the air supplying conduits has a second coupling portion arranged thereon, and the second coupling portions are respectively coupled to the first coupling portions of the air conduits at the upper end or the lower end.

20. A breathable seat cushioning device for children, comprising:
a seat body having a plurality of receiving grooves longitudinally arranged thereon, and a front side of the seat body having an air permeable portion in air communication with the receiving grooves;
a plurality of air conduits respectively disposed in the receiving grooves and each air conduit having a plurality of air outlets arranged thereon;
a fan module having a casing and at least one fan blade pivotally coupled to and arranged in the casing, wherein the fan module is in air communication with the air conduits; and
a heater disposed proximate to an air outlet of the fan module.

21. The breathable seat cushioning device as recited in claim 20, wherein the seat body has a plurality of guiding grooves laterally arranged thereon and transversely arranged with respect to the receiving grooves.

22. The breathable seat cushioning device as recited in claim 20, wherein the heater includes a heat generating member and at least one thermally conducting fin connected to the heat generating member, and is arranged in the casing of the fan module.

23. The breathable seat cushioning device as recited in claim 20 further comprising:
a playback device arranged on the fan module or the seat body.
